(19) United States
(12) Patent Application Publication
(10) Pub. No.: US 2026/0048313 A1
(43) Pub. Date: Feb. 19, 2026

(54) WATER TRAINING INTEGRATED MACHINE FOR DRAGON BOAT RACING

(71) Applicant: YANGTZE UNIVERSITY, Jingzhou (CN)

(72) Inventors: Shiping SUN, Jingzhou (CN); Zikang ZHOU, Jingzhou (CN); Pan XIA, Jingzhou (CN); Wenbo DING, Jingzhou (CN); Wenke YANG, Jingzhou (CN); Junhao CHEN, Jingzhou (CN); Tengfei LI, Jingzhou (CN); Daochen YAO, Jingzhou (CN); Wenqiang HUANG, Jingzhou (CN); Chuang DIAO, Jingzhou (CN); Wenhui ZHANG, Jingzhou (CN); Yiyue ZHENG, Jingzhou (CN); Xinyue WANG, Jingzhou (CN); Yizhen ZHANG, Jingzhou (CN)

(73) Assignee: YANGTZE UNIVERSITY, Jingzhou (CN)

(21) Appl. No.: 19/216,724

(22) Filed: May 23, 2025

(30) Foreign Application Priority Data
Aug. 13, 2024 (CN) 202411103099.8

(51) Int. Cl. A63B 69/06; A63B 24/00

(52) U.S. Cl. CPC A63B 69/06; A63B 24/0087; A63B 2220/51; A63B 2225/50

(57) ABSTRACT

The present invention relates to sports training and testing technology and discloses a water training integrated machine for dragon boat racing. The system comprises a dragon boat, a shore data processing device, and a water device. The water device is mounted on a blade of the dragon boat and includes a sensor, a data operation unit, and a communication transmitting module, sequentially connected. These components are powered by a power supply module. The data operation unit communicates with the shore data processing device via the communication transmitting module. The shore data processing device comprises a data processing module, a display module, and multiple communication receiving modules. The display module and communication receiving modules are electrically connected to the data processing module. This technical solution enables accurate measurement and real-time monitoring of stroke force during water sports training, thereby enhancing performance analysis and training efficiency.

### TECHNICAL FIELD

The present invention belongs to the field of sports training and testing technology, particularly relates to a water training integrated machine for dragon boat racing.

### BACKGROUND OF THE INVENTION

Dragon boat is a traditional sport with a long history. In the movement of the dragon boat, the stroke force and stroke rate of the athletes are crucial to improve the speed and stability of the dragon boat. In the conventional measurement process, the measurement effect of the paddles mainly relies on the observation of the coaches and the self-perception of the athletes and these methods are rather subjective and lack detailed data support. Additionally, conventional training methods cannot provide real-time feedback, coaches and athletes can only summarize at the end of the training, hence missing the opportunity to make timely adjustments.

In the existing technology, technical approaches have been introduced to assist dragon boat training in some studies. For example, some teams have used video analysis systems to record and analyze the stroke movements of their team members in order to obtain more objective data. However, this method requires a lot of post-processing work and does not provide real-time feedback. Additionally, some wearable devices have been used to record team members'physiological data, but these data do not directly reflect the quality and efficiency of the stroke movement.

### SUMMARY OF THE INVENTION

An objective of the present invention is to provide a water training integrated machine for dragon boat racing to solve the problems existing in the above existing technology.

In order to achieve the above objective, the present invention provides a water training integrated machine for dragon boat racing, including a dragon boat, a shore data processing device and a water device, wherein the water device is mounted on a blade of the dragon boat, each of the water devices includes a sensor, a data operation unit and a communication transmitting module connected in sequence, the sensor; the data operation unit and the communication transmitting module are connected to a power supply module, and the data operation unit is connected to the shore data processing device in a communication manner through the communication transmitting module.

The shore data processing device includes a data processing module, a display module and a plurality of communication receiving modules, wherein the display module and each of the communication receiving modules are electrically connected to the data processing module, and each of the communication receiving modules is connected in one-to-one correspondence to the communication transmitting modules in each of the water devices.

Optionally, the data operation unit includes an operation processing module and a signal amplification module, and the sensor, the operation processing module, the signal amplification module, and the communication transmitting module are electrically connected in sequence.

Optionally, the signal amplification module adopts a low-noise amplifier.

Optionally, the operation processing module adopts a single-chip microcomputer.

Optionally, the sensor adopts a strain sensor.

Optionally, a data storage sub-module is integrated into the data processing module.

Optionally, the communication receiving module and the communication transmitting module are connected by a LoRa communication protocol/2.4G communication protocol.

The technical effects of the present invention are:
the water training integrated machine for dragon boat racing provided by the present invention can realize accurate measurement and real-time monitoring of stroke force in water sports training, adjust the training mode of athletes in real time, and improve the effectiveness and convenience of training, meanwhile, the device integrates the integrated design of sensors, signal processing and wireless communication, and simplifies the deployment and operation flow of the device, and the modular design of the device is convenient for maintenance and upgrading, so that it can adapt to the continuously developing training requirements.

### BRIEF DESCRIPTION OF THE DRAWINGS

To explain the examples of the present invention or the technical solutions in the prior art more clearly, a brief introduction will be made to the accompanying drawings used in the examples or the description of the prior art. It is obvious that the drawings in the description below are only some examples of the present invention, and those ordinarily skilled in the art can obtain other drawings according to these drawings without creative work.

The accompanying drawings, which form part of this application, are used to provide a further understanding of this application, and the schematic embodiments of this application and their illustrations are used to explain this application and do not constitute an undue limitation of this application. In the accompanying drawings:

FIG. 1 is a schematic diagram of a connection structure of a water training integrated machine for dragon boat racing in an embodiment of the present invention;

FIG. 2 is a connection structure diagram of a water device and a shore data processing device in an embodiment of the present invention;

FIG. 3 is a schematic diagram of a system structure of a water device mounted on a paddle in an embodiment of the present invention;

FIG. 4 is a schematic diagram of a system structure of a shore data processing device in an embodiment of the present invention;

FIG. 5 is a schematic diagram of a communication connection between a wireless communication transmitting module and a shore receiving module in an embodiment of the present invention;

Reference numerals in figures: 1, a shore data processing device; 2, a host computer display module; 3, a wireless communication receiving module; 4, a blade; 5, a power module; 6, an operation processing module; 7, a signal amplification module; 8, a sensor module; 9, a wireless communication transmitting module; 10, a No.2 blade; 11, a No.3 blade; 12, a No.4 blade; 13, a No. K blade; and 14, a No. N blade.

### DETAILED DESCRIPTION OF THE EMBODIMENTS

The following clearly and completely describes the technical solutions in embodiments of the present invention with reference to the embodiments of the present invention. Apparently, the described embodiments are only some but not all of the embodiments of the present invention. All other embodiments obtained by those of ordinary skill in the art based on the embodiments of the present invention without involving any creative effort shall fall within the scope of protection of the present invention.

In order to facilitate the understanding of the present invention, the present invention will be described more fully hereinafter with reference to the relevant accompanying drawings, a number of embodiments of the present invention are given, however, the present invention may be realized in many different forms and is not limited to the embodiments described herein, conversely, these embodiments are provided for the objective of making the disclosure of the present invention more thorough and comprehensive.

It should be noted that when an element is described as being “fixed arranged” with another element, it may be directly on the other element or there may be a centered element, and when an element is considered to be “connected” to another element, it may be directly connected to the other element or there may be both centered elements. The terms “vertical,” “horizontal,” “left,” “right,” and similar expressions are used herein only for the purpose of illustration.

The terms “contains”, “includes”, “has”, “comprises”, etc., as used herein, are open-ended terms, i.e., they are meant to encompass but are not limited to.

Unless otherwise defined, all technical and scientific terms used herein have the same meanings as commonly understood by those skilled in the art of the present invention, terms used herein in the specification of the present invention are merely for the purpose of describing specific embodiments and are not intended to be limiting, and the terms “and/or” as used herein include any and all combinations of one or more of the relevant listed items.

It is to be noted that the embodiments and the features in the embodiments in the present application may be combined with each other without conflict. The present application will be described in detail below with reference to the accompanying drawings and in connection with the embodiments.

### Embodiment 1

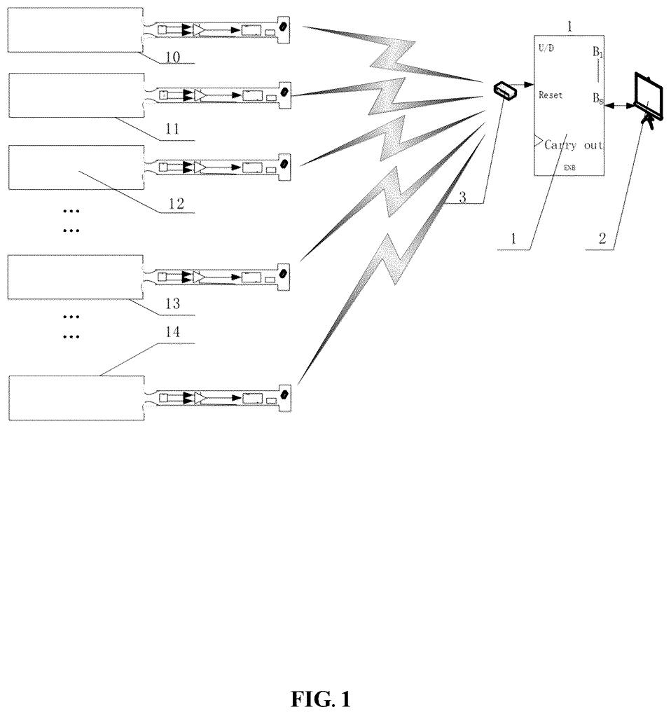

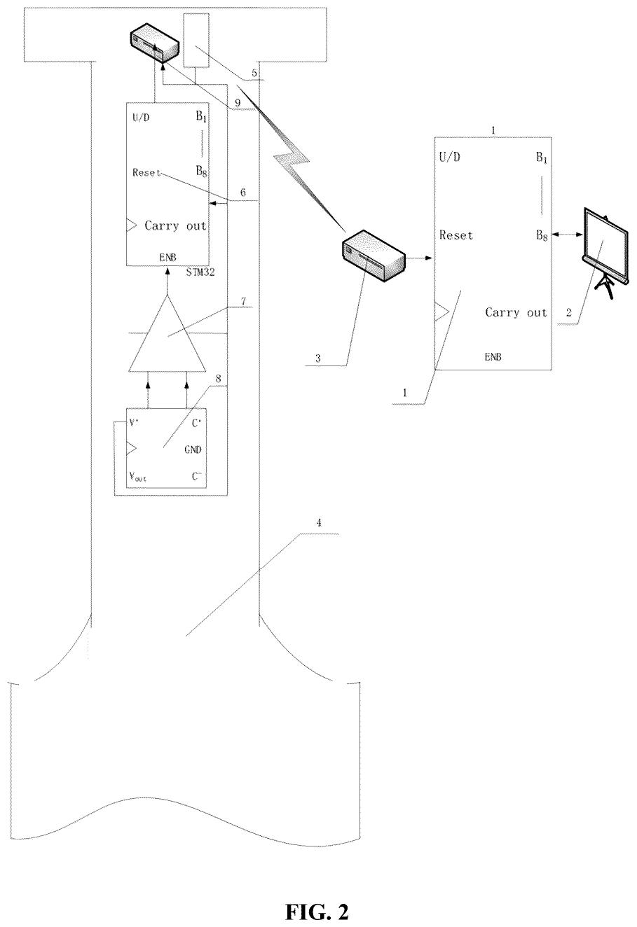

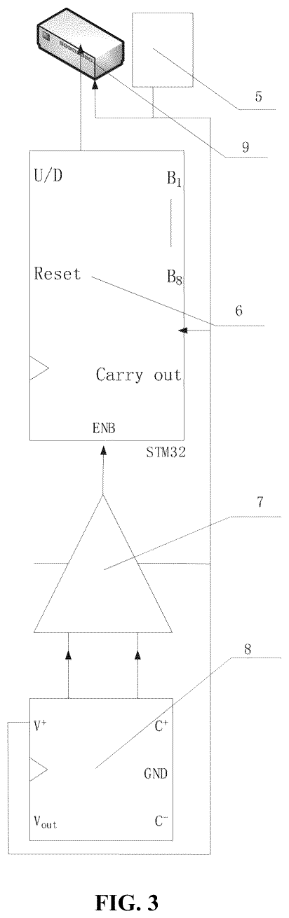

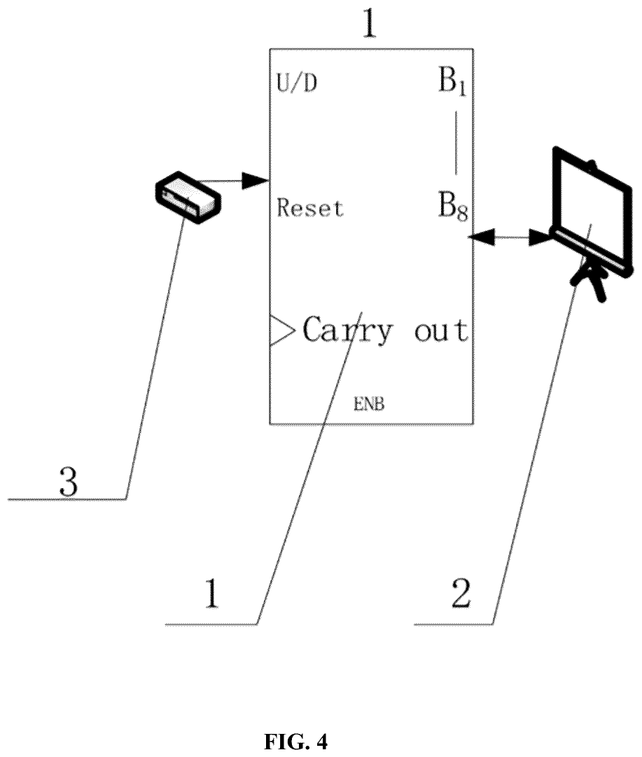

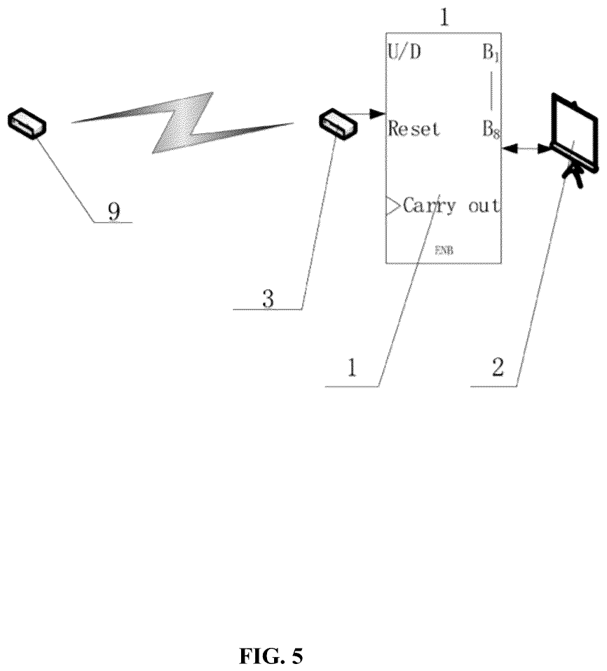

As shown in FIGS. 1-5, the embodiment provides a water training integrated machine for dragon boat racing, including the dragon boat, the shore data processing device 1 and the water device, wherein the water device is mounted on the blade 4 of the dragon boat, each of the water devices includes the sensor, the data operation unit and the communication transmitting module connected in sequence, the sensor, the data operation unit and the communication transmitting module are connected to the power supply module, and the data operation unit is connected to the shore data processing device 1 in a communication manner through the communication transmitting module; the shore data processing device 1 includes the data processing module, the display module and the plurality of communication receiving modules, wherein the display module and each of the communication receiving modules are electrically connected to the data processing module, and each of the communication receiving modules is connected in one-to-one correspondence to the communication transmitting modules in each of the water devices.

An objective of the embodiment is to provide a water training function integrated measurement device that can efficiently measure stroke force, stroke rate and other data, so as to assist coaches and athletes to better understand the training process, optimize the technical movements, and enhance the training effect.

The water training function integrated measurement device of this embodiment mainly includes the shore data processing device 1 and a water device arranged on the paddle, the water device includes a power module 5, the operation processing module 6, the signal amplification module 7, a sensor module 8, the wireless communication transmitting module 9, the input end of the operation processing module 6 is connected to the signal amplification module 7, the signal amplification module 7 is connected to the sensor module 8, and the sensor module 8 is arranged on the paddle; the output end of the operation processing module 6 is connected to a wireless communication transmitting device, the wireless communication transmitting module 9 on each paddle is wirelessly connected to the only wireless communication receiving module 3 on the shore to ensure that the data can be stably transmitted to the shore.

The shore data processing device 1 includes a data processing module, a host computer display module 2, and the wireless communication receiving module 3, the input end of the data processing module is connected to a wireless communication receiving module 3, the wireless communication receiving module 3 is wirelessly connected to the wireless communication transmitting module 9 on a plurality of paddles in the water through wireless signals to ensure that the data of each paddle can be independently received and processed, the output of the data processing module is connected to the host computer display module 2 to display and further analyze the processed data.

The strain force is measured by the sensor and converted into an electrical signal to be output, and the signal is amplified by the signal amplification module 7, the operation processing module 6 receives the amplified signal for data processing and operation, and the wireless communication module converts the processed data into a wireless signal for transmission; the shore wireless communication module receives the transmitted data and transmits the data to the host computer display module 2 through the processing module, the host computer display module 2 will display the required data in real time, and the coach can use these data as a reference for training.

The power module 5 of the water training function integrated measurement device is an important part of this embodiment, the power module 5 is responsible for providing a stable and reliable power supply for sensors, signal amplification module 7, operation processing module 6, and wireless communication module. Due to the particularity of the water environment, the power module 5 also has waterproof and moisture-proof performance to ensure that the device can work for a long time in water.

The sensor of the water training function integrated measurement device is a high-sensitivity strain sensor, the strain sensor is arranged at the blade 4 of the water sports device and is responsible for detecting and recording the key parameters of the water sports device during use, and converts the analog signal into a digital signal and transmits to the signal amplification circuit.

The signal amplification module 7 of the water training function integrated measurement device is the key link between the sensor and the operation processing module 6. The signal amplification module 7 is responsible for effectively amplifying the weak signal collected by the sensor, while ensuring that the signal is not distorted to improve the quality of the signal and ensure the accuracy of the data. The signal amplification module 7 uses a low-noise amplifier and anti-interference circuit design to ensure the stability and accuracy of data transmission.

The operation processing module 6 of the water training function integrated measurement device is to realize the functions of data processing, analysis and control. The operation processing module 6 uses STM32 single-chip microcomputer as the core processor to extract the features of the received effective amplified signals and applies various algorithms (fast Fourier transform) to identify the key performance indicators such as stroke force and stroke rate, further statistical analysis and data processing are performed on the extracted features, and the stroke rate of the athletes is calculated in real time by using the preset formula. The operation processing module 6 further has a self-calibration function to ensure data accuracy in long-term use.

The wireless communication transmitting module 9 of the water training function integrated measurement device is a key component to realize remote data transmission. The wireless communication transmitting module 9 is responsible for encapsulating the data processed by the operation processing module 6 into a wireless transmission format and modulating it to ensure the stability and reliability of the data during wireless transmission. It is sent to the shore receiving module in the form of electromagnetic waves.

The wireless communication receiving module 3 of the water training function integrated measurement device is a key component to realize remote data reception. The wireless communication receiving module 3 is responsible for receiving the data transmitted by the wireless communication transmitting module 9, processing the data through the demodulator in the module, decoding it, and restoring the modulated signal to the original structure of the data. Finally, the data is transmitted to the data processing module.

The data processing module of the water training function integrated measurement device is the key to further analyzing and processing the relevant data of water sports devices. The data processing module is responsible for receiving the data transmitted by the wireless communication receiving module 3 to extract useful information and store all the information in order to compare the historical data and provide formatted data for the host computer display module 2.

The host computer display module 2 of the water training function integrated measurement device is the key to realizing data visualization and user interaction. The host computer display module 2 is responsible for receiving the data transmitted by the shore data processing device 1 and displaying it to the coaches with a digital and graphical interface. The host computer display module 2 has an intuitive user interface, so that coaches can intuitively understand the meaning of data, and allow coaches to query and review historical data for comparative analysis. The host computer display module 2 has greatly improved the understanding and utilization of training data by coaches and athletes.

The water training function integrated measurement device of this embodiment, realizes accurate measurement and real-time monitoring of the stroke force in water sports training, the real-time adjustments can be made to the training mode of athletes, and the effectiveness and convenience of training are improved. Meanwhile, the device integrates the integrated design of the sensor, signal processing, and wireless communication, and simplifies the deployment and operation process of the device, and all devices have waterproof performance, which can greatly improve the stability of the system. The modular design of the device facilitates maintenance and upgrades, thus enabling it to adapt to evolving training requirements.

The water training function integrated measurement device of this embodiment. When athletes are training on water, the sensor module 8 is arranged on the key force point of the paddle, and the force data of the paddle is collected in real time to ensure that the change of the stroke force can be accurately measured. The data is amplified by the signal amplification module 7, the part uses a low-noise amplifier to improve signal strength and stability. Then the data is processed by the operation processing module 6 (STM32 single chip microcomputer). The processed data is sent to the wireless communication receiving module 3 (2.4G wireless module) on the shore in the form of a wireless signal through the wireless communication transmitting module 9 (2.4G wireless module), the module is responsible for converting the signal back to the digital signal. Then the data processing module decodes and further analyzes the received signal, stores the data and transmits the data to the host computer module through the RS-485 circuit. The host computer display module 2 provides an interactive interface for coaches, which can display various data in real time, and can also view historical data through a graphical interface.

As shown in FIG. 1, the water training function integrated measurement device supports synchronized monitoring of a plurality of blades 4. The sensor module 8 on each blade 4 works independently, and the data is sent to the communication receiving module on the shore through their respective wireless communication transmitting module 9. The receiving module can receive the data of a plurality of blades 4 at the same time and transmit it to the data processing module for comprehensive analysis. The synchronous monitoring of the plurality of blade 4 can help coaches understand the coordination and synchronization problems in team training. By comparing the force data and stroke rate of different blades 4, the coach can find out the uncoordinated links in the team and carry out targeted adjustments and training.

All the above mentioned are merely better specific embodiments of the present application, but the scope of protection of the present application is not limited thereto, and any changes or substitutions that can be conceivably made by any person skilled in the art within the scope of the technology disclosed in the present application should be covered by the scope of protection of the present application. Therefore, the scope of protection of this application should be based on the scope of protection of the claims.

What is claimed is:

1. A water training integrated machine for dragon boat racing, comprises a dragon boat, a shore data processing device (1) and a water device, wherein the water device is mounted on a blade (4) of the dragon boat, each of the water devices comprises a sensor, a data operation unit and a communication transmitting module connected in sequence; the sensor, the data operation unit and the communication transmitting module are connected to a power supply module, and the data operation unit is connected to the shore data processing device (1) in a communication manner through the communication transmitting module;
the shore data processing device (1) comprises a data processing module, a display module and a plurality of communication receiving modules, wherein the display module and each of the communication receiving modules are electrically connected to the data processing module, and each of the communication receiving modules is connected in one-to-one correspondence to the communication transmitting modules in each of the water devices.

2. The water training integrated machine for dragon boat racing according to claim 1, wherein the data operation unit comprises an operation processing module (6) and a signal amplification module (7), and the sensor, the operation processing module (6), the signal amplification module (7), and the communication transmitting module are electrically connected in sequence.

3. The water training integrated machine for dragon boat racing according to claim 2, wherein the signal amplification module (7) adopts a low-noise amplifier.

4. The water training integrated machine for dragon boat racing according to claim 2, wherein the operation processing module (6) adopts a single chip microcomputer.

5. The water training integrated machine for dragon boat racing according to claim 1, wherein the sensor adopts a strain sensor.

6. The water training integrated machine for dragon boat racing according to claim 1, wherein a data storage sub-module is integrated into the data processing module.

7. The water training integrated machine for dragon boat racing according to claim 1, wherein the communication receiving module and the communication transmitting module are connected by a LoRa communication protocol/2.4G communication protocol.
